(19) United States
(12) Patent Application Publication
(10) Pub. No.: US 2002/0112025 A1
(43) Pub. Date: Aug. 15, 2002

(54) Dynamic download of 3D information

(76) Inventors: Mats Johansson, Rancho Santa Margarita, CA (US); Daniel Hallstrom, Gothenburg (CH); Vinh-Sang Tri, Gothenburg (CH); Martin Green, Gothenburg (CH); Nils Andersson, Molnlycke (CH)

Correspondence Address: EON Reality, Inc., Suite 150, 31 Technology Drive West, Irvine, CA, 92618, US

(21) Appl. No.: 09/877,881

(22) Filed: Jun. 8, 2001

Related U.S. Application Data
(60) Provisional application No. 60/210,429, filed on Jun. 8, 2000.

(51) Int. Cl. G06F 15/16

(52) U.S. Cl. 709/217

(57) ABSTRACT

A dynamic loading and unloading of model files over the Internet or a local network from a repository of objects located at a URL. The model file contains all aspects of the available features of the 3-D object including 3-D geometry, texture (image), audio, text, video as well as behavior and interactivity (logic), that is the sub-components or elements of the object model file. The models include ways of representing graphic images, which include the designation of endpoints rather than each point of an image. The present invention divides the model file into the sub-components and downloads each component separately in any order. Typical model file size is from approximately 10 Kbytes to about 1.5 Mbytes. Geometry describes the physical characteristics in a 3-D file, such as the shape and size. Images consist of a texture of the geometry. The sub-components or elements are downloaded separately to form a complete 3-D model. These elements are downloaded dynamically. That is when required or selected separate from an overall scene and may be individually positioned about a particular environment.

### BACKGROUND OF THE INVENTION

1. Field of the Invention

The field of this invention relates to the download of image files. In particular this invention relates to the download of and automatic update of 3-D Geometry object files, which may be rapidly downloaded by Users and stored locally.

2. Background Information

Many examples of downloading of image files are present in the computer industry most prevalent are the many examples of downloadable images, which are present on the Internet as image files, embedded in web pages.

Each image file which is downloaded is downloaded as a complete unit and dependent on the particular format and the particular internet connection may take a considerable amount of time to down load.

The concept of objects, which may be created by a User, is well known and is described in an attached document entitled EON Reality White Paper, which is attached hereto and incorporated herein by reference.

However, rapid download of objects in particular graphic objects remains a problem due to the large size and amount of data that must be downloaded for various geometries. What is required is a rapid way of downloading files of manageable size.

### BRIEF SUMMARY OF INVENTION

The dynamic load of the present invention allows for dynamic loading and unloading of model files over the internet from a repository of objects located at a URL or any other type of protocol that uses internet (TCP/IP) as a carrier for the data. A summary of the Dynamic Load of the present invention is entitled EON Reality, Inc. is attached hereto an incorporated herein by reference a confidential background Description entitle Background Description is also attached hereto and is incorporated herein by reference. The model file contains one or more of the aspects of the available features of the 3-D object including 3D geometry, 2D Graphics (texture, image), audio, video as well as behavior and interactivity (logic), that is the sub-components or elements of the object model file. The models include ways of representing graphic images, which include the designation of endpoints rather than each point of an image. The present invention divides the model file into the sub-components and downloads each component separately in any order. The order may or may not be defined by the 3-D Geometry creator or the User.

Typical file size is from approximately 200 Kbytes to about 1.5 Mbytes. It should be noted that such files can be smaller and easily could be larger, e.g. video film could be up to 50 to 60 megabytes for a video clip.

Dynamic downloading of the present invention downloads 3-D object models in subsections. These subsections or elements include geometry data and image data for example as well as other characteristics of the object model. Geometry describes the physical characteristics in a 3-D file, such as the shape of a soft drink can of aluminum, for example, which would include the characteristic cylindrical shape, the gloss or shine of metal and basic color. Images consist of the texture of the can geometry such as the application of a label and other distinguishing characteristics of the can, which is superimposed on the geometry.

In the dynamic download system of the present invention, the 3-D object model file can be split into many parts and downloaded one part at a time. Generally this includes the basic sub-components, i.e. geometry data, image data, sound data, video data and logic. However, the basic sub-components may also be subdivided such as in the case of a large image or video file for example. Thus in the event of any connection failure the previously downloaded part need not be downloaded again. Subsequent downloads will be added to that which was already received. It should be noted that downloadable 3-D model file may contain more than one 3-D object file, each of which would have at least geometry data and more than likely image data to show the character of the surface of the geometry.

As each part is downloaded it is dynamically displayed or preloaded for later display as selected. Initially there is usually some 3-D environment such as a room or other space into which a plurality of 3-D objects are placed. The environment is always downloaded first and started before any dynamic load object can be downloaded. The rest of the 3-D objects may be downloaded in any order as determined by the designer of the 3-D Object. The environment may be an empty object or it may include selected object files. If the environment is a room for furniture, it may include walls and pictures. If a show room for automobiles it may only be a floor in space. If a large file of an automobile is to be downloaded, for example, it can be subdivided into first the outside of the automobile (the environment). Then the inside elements such as seats, dashboard, steering wheel, engine, etc. are downloaded as determined by the automobile object designer. Each downloaded object is not dependent on any other download object. In the case of the automobile showroom environment for the automobile the automobile is a multi-object model.

It is contemplated that commercial suppliers of the real products they have for sale would design virtual products and place them in a 3-D catalog of models accessible by buyers who wish to view the products alone or in a particular environment.

The present invention permits the download of office furniture, for example, into a room, and the positioning of the furniture where desired. The User would access the virtual product and download as many of the objects, such as chairs for placement in an environment and can design a customized office. As an option, each access of a URL for download of the models is a session. Sessions are initiated by the buyer or other third parities, a User, accessing the site. A verification of the availability of the site is made and if approved the User is allowed to download selected 3-D models and manipulate them as desired. Once the session is terminated, the operation of the program terminates although all of the models downloaded remain on the Users system. This is accomplished by downloading an ActiveX component onto the Users system, which permits download and allows local communication with the program operating on the target URL to create a local copy of the environment with the various objects. It is preferred that this ActiveX component and any other necessary software components be downloaded from a central server or other locations such as the approving server which eliminates multiple code bases and need to continually update software at a number of different locations. The downloaded software also prompts to install external components if necessary, such as Direct 3D or scripting software components as well.

Once the session ends, the ActiveX component is terminated. Each downloaded model object may be copied once it is downloaded to display a plurality of such objects in the environment rather than multiple downloads of the same object. Such a copied object may be positioned as desired independent of the object copied. In addition, in future sessions where a particular downloaded model has been modified or is replaced by the supplier, the replacement of any particular model will cause all of the duplicates to also be replaced automatically by indicating that all objects for any particular model is to be substituted.

### BRIEF DESCRIPTION OF THE SEVERAL VIEWS OF THE DRAWINGS

FIG. 1 is a diagram of the ActiveX component of the invention with objects and other information.

FIG. 2 is a diagram of showing the session approval server, the User PC and the model repository location

FIG. 3A-3F is a flow diagram of the downloading of the model objects.

### DETAILED DESCRIPTION OF THE INVENTION

As noted above, dynamic downloading permits the User to configure a 3-D world by allowing the rapid download of various 3-D models, including an environment and 3-D object models which populate the 3-D world by forming the data for the various objects into component parts or elements. The elements comprise but are not necessarily limited to:

1. The 3D Models (geometry),

2. 2D Graphics, (textures, images),

3. Digital audio,

4. Digital video and

5. Object behavior and interactivity (logic).

Object behavior and interactivity relate generally to any kind of logic that can be programmed for the interactive 3D application. The logic may includes but is not limited to handling click responses on objects such as clicking on a door to open it, thus providing an interactive capability, or it may be in the form of collision detection (which prevents the user from moving through a wall for example). It may also include the generation of rain; explosions or even movement of the object such as a swimming fish, and using embedded code like script.

When these various elements are downloaded they form the 3-D object. It should be noted that all objects downloaded may not in fact be visible and the so called 3-D object may only be a sound clip, or code for an action which occurs when the cursor reaches a certain location and the invention is not to be limited to a complete downloaded 3-D object.

With reference to the drawings, FIG. 1 shows a typical User screen 1, the ActiveX object 2 is downloaded to the Users system when the User contacts the catalog URL having the catalog information. While the described specific embodiment is an ActiveX control, any kind of plugin may be used that can perform the necessary tasks for implementing the dynamic load described herein and the invention is not to be limited to only an ActiveX implementation. The local software (usually a web browser) shows textual instructions or advertising 6 and other locally generated graphic objects 7.

FIG. 2 illustrates the User system 8 interconnection through the Internet 11 to the catalog URL system 10. Before download of any 3-D object can begin, the Session approval server is interrogated and must grant approval to the User 8 before a session can begin. Such approval may be granted on a session by session basis, that is each time a catalog URL 10 is contacted or may be granted on an object by object basis before download is commenced. Approval may be conditioned on payment by either the User or the catalog vendor. A license may then be granted for engaging in a session or downloading vender 3-D objects as is determined by the vendor system.

Each time the User disconnects from a particular vendor a new session and approval must be obtained to commence a new session, which allows interconnection of the vendor and the User information even though the downloaded 3-D objects are resident on the User machine. The plugin or the ActiveX component need only be downloaded once since it remains on the User's system.

The ActiveX component will search for 3-D objects and environments on the User system. There may be several projects, which include environmental and 3-D object information stored on the User system, which are accessed by the ActiveX component for manipulation by the User in the environment. Each project may contain pointers to downloaded 3-D objects and environments and the User may manipulate the various 3-D object positions in the environment or merely move through the environment and observe the different views of the 3-D objects dependent on the virtual location in the environment.

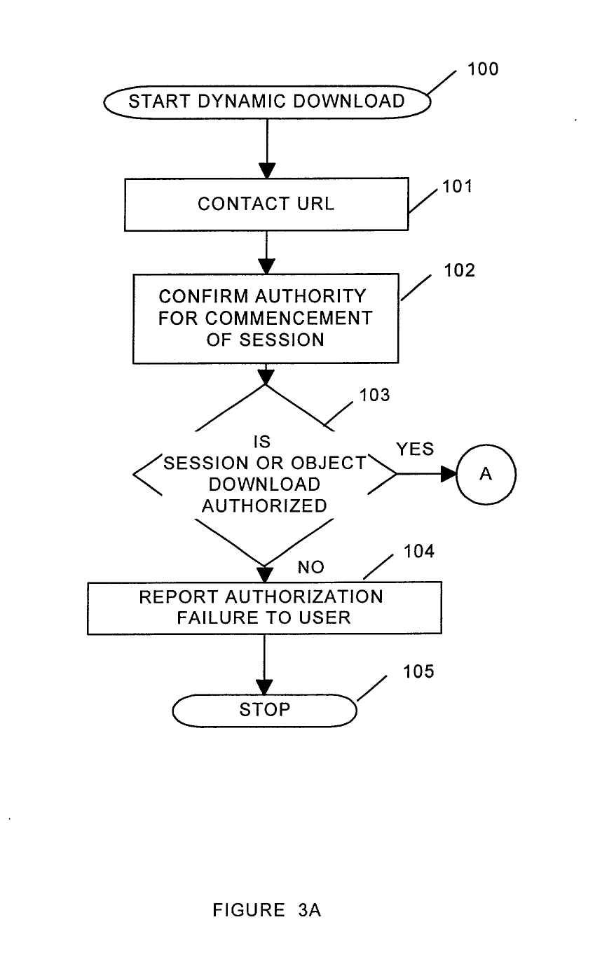

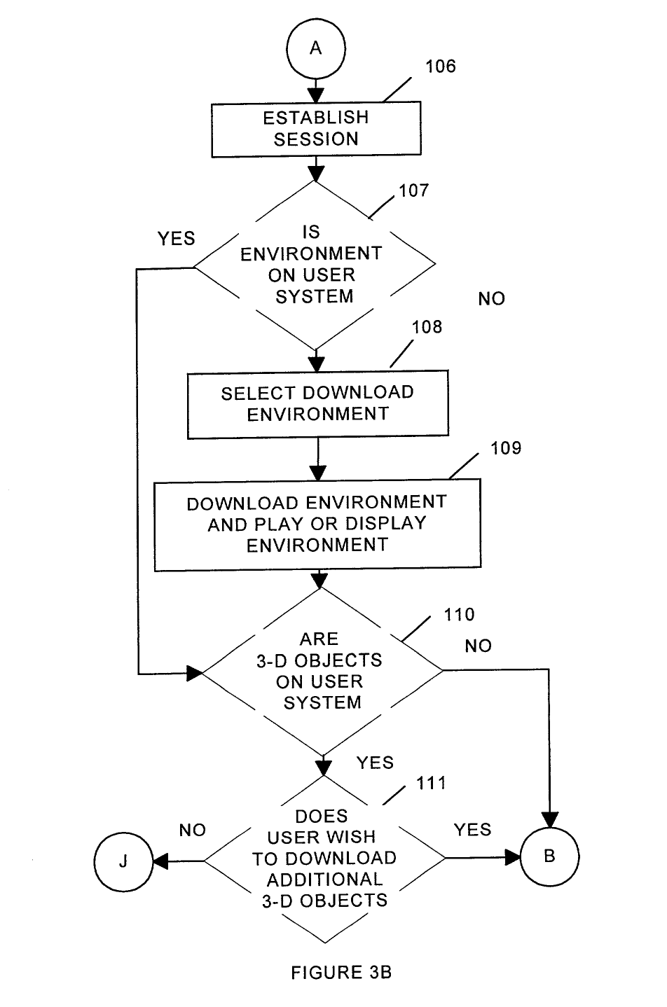

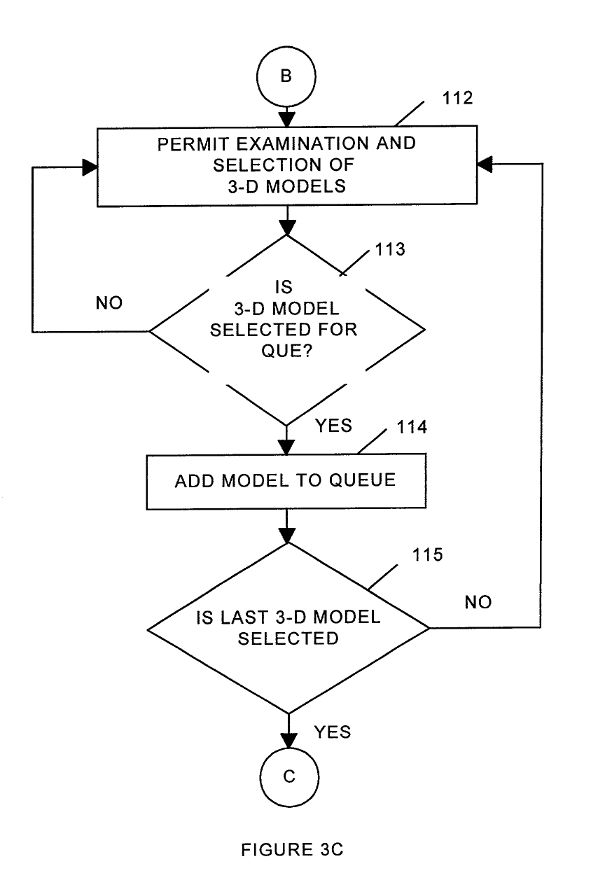

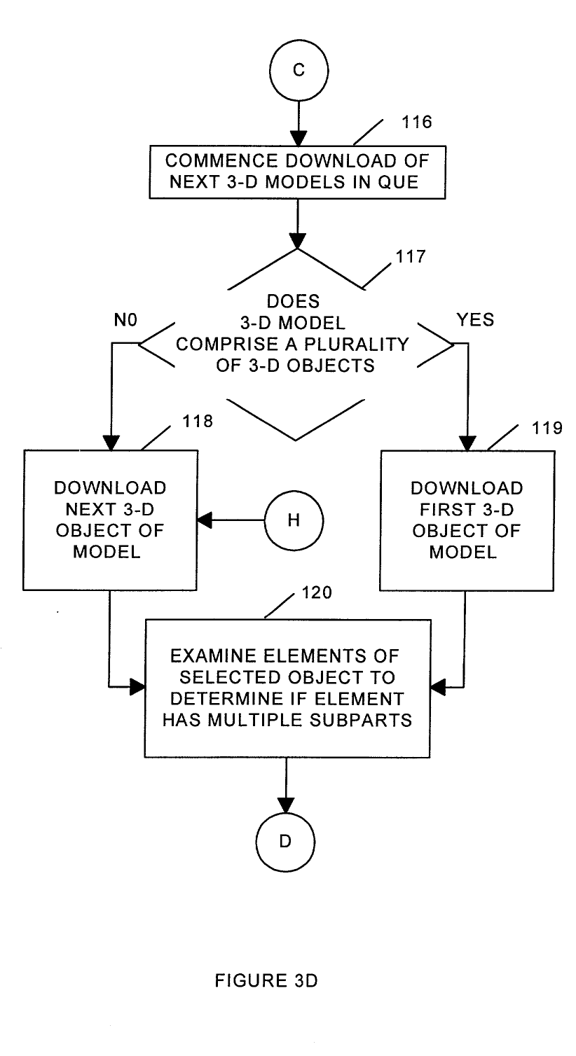

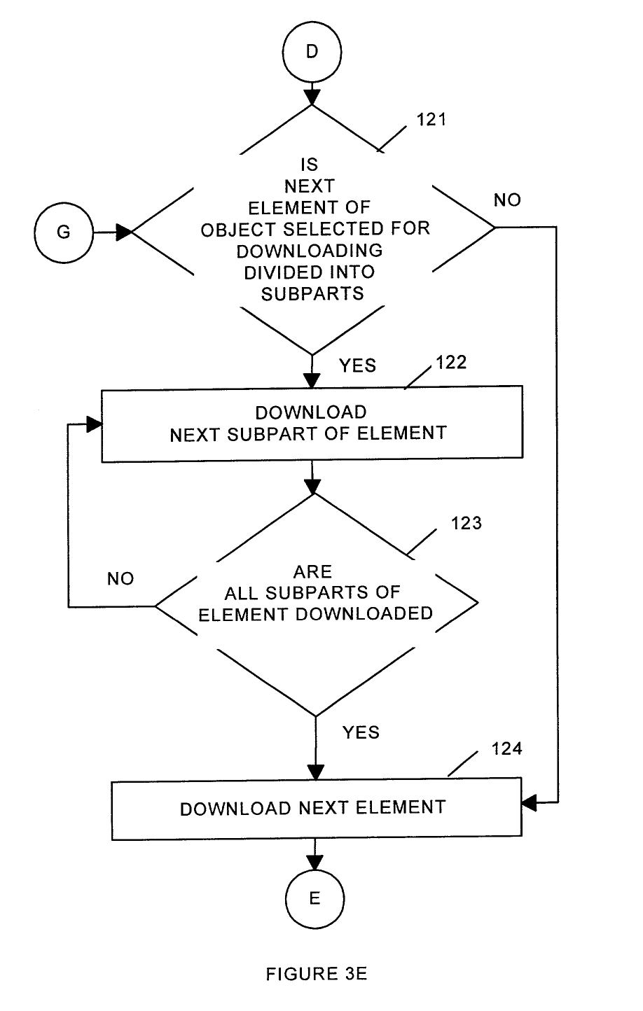

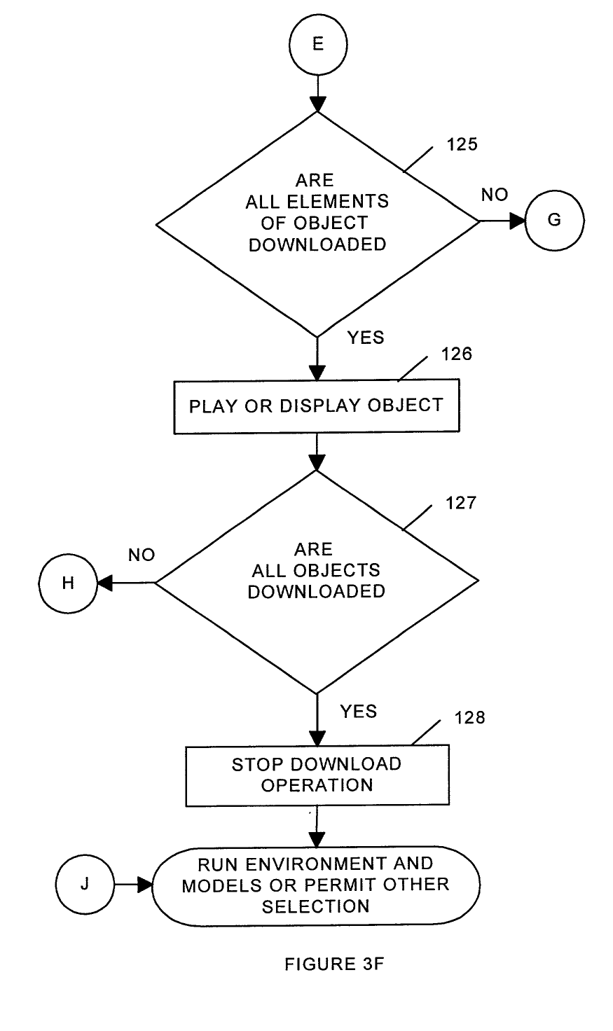

FIG. 3A through 3F illustrate the process of contacting the Catalog URL 10 and the Approval Server 9. As shown in FIG. 3A, a session commences, STEP 100 by contacting the Catalogue URL 10, step 101. The catalog URL initiates an approval request to the Session approval server 9, step 102. As noted above this approval can be on a session by session basis or on an object by object basis or both per session and per downloadable object. In either case, for the User to manipulate the objects or move in the environment a link must be established with at least one catalog URL 10. For example, as shown in FIG. 2, if the catalog URL 10 is an automobile dealer, the other catalog URL 10′ may be a manufacturer of automobile seats for the automobile and thus provides a different downloadable 3-D object. In addition, there may be multiple seat manufacturers thus providing multiple additional catalog URL's 10′. Each of these URL's must be contacted to download their respective 3-D objects. At least one session must be maintained in order to manipulate the 3-D objects or operate in the environment.

If a Session is not authorized or the 3-D object download is not approved, step 103 the system will notify the User and the session does not commence or the object cannot be downloaded, STEP 104, and the particular operation stops, step 105. If the Session is not authorized, the User is unable to use the ActiveX component. If the session is authorized and an object download is not approved, the User will still be able to use the ActiveX component and manipulate previously downloaded objects in the environment.

If the session is authorized, step 103; the User establishes the session, step 106, the ActiveX component or other plugin is initiated on the Users system. Through the ActiveX component the User may examine and select 3-D object models for download.

Once the session 106 is established the system determines if the environment is on the user system, step 107, if it is not, the user may select from any multiple environments, step 108 and the 3-D environment will be downloaded and started 108. If there is only a single environment available, it is selected and downloaded.

If an environment object is present on the User system, step 107, the system determines if there are 3-D objects on the User system, step 110. If there are 3-D objects the system determines if the User wishes to download additional 3-D objects, step 111. If not the download process terminates, step 128. If there are no 3-D objects on User system, step 110, or the User wishes to download additional 3-D objects, step 111, the User is permitted to examine and select 3-D models for download, step 112. The system checks to determine if a 3-D model is selected for the Queue, step 113 and adds the selected 3-D model to the queue, step 114, when the last model is selected, step 115, the download of the 3-D models occur in order 116. It is possible that a particular 3-D object may contain a number of other 3-D objects. For example, a 3-D object of an automobile may be selected for download from an auto dealer Catalog URL 10. The automobile may comprise separate 3-D objects for the motor, for seats, stereo systems and a host of other features. If multiple 3-D objects are present in a 3-D model, step 117, the system commences download with the first Object in the 3-D model, step 119. Each object may have a number of sub-object elements such as a geometry sub-object element which defines the form of the object and a basic color or appearance. However, it is likely that the object will also have an image element superimposed on the geometry, as well as digital audio element associated with the object, a digital video clip element associated with the object and object behavior and interactivity element (logic) associated with the object. Logic may be introduced or created by including program code, which is integrated to the object to control its behavior or other activities. Such logic may be used on the occurrence of certain events, such a the completion of download, on a mouse click or other selection of the object or by activity associated with a different object all dependent on the objectives of the designer of the code. Other types of elements may also be part of the 3-D image as may determined from time to time dependent on the degree of visual or audio impact desired. The principal is that instead of a 3-D Object being downloaded as a unit, it can be subdivided into sub-elements as described above. Various size thresholds can be established to automatically determine if subdivision into sub-elements is to be made for the purpose of dynamic downloading or the designer can code the subdivision subelements. This feature is provided to provide the designer with full control or allow automation. If only part of a previously downloaded object or a sub-object changes, then only that part is dynamically updated during a session. The ActiveX component enters a loop where it checks a queue for any requests for downloading parts (dynamic objects). If the queue is empty, the system is it checked again otherwise it downloads the first element in the queue and it its displayed. While displaying an object a new request from the downloaded object to download one or more objects may occur. These will be placed in the queue and downloaded when the check again occurs. As noted herein the displayed object may or may not actually have a visual effect on the screen, but may just include some logic that doesn't have any visual effect. In addition, there are at least two ways of entering requests in the queue. First by a recent downloaded object present in the queue or by a request from an activity outside the ActiveX component such as for example by pressing a button in a web-page which will result in the download request inside the ActiveX control. If a system fault occurs during a download, then the balance of the 3-D object may be downloaded during the next session. Where the object does not comprise multiple 3-D objects, step 117, the download of only that object then commences, step 118. In addition to downloading a 3-D object on an element by element basis, large elements may be segmented into subparts. Prior to downloading a 3-D object element, the system examines the elements of the 3-D object to determine if any elements have subparts, step 120. If the element is divided into subparts, step 121 then the download commences with the first subpart, 122 and continues, step 123 until all of the subparts of the element are downloaded, step 122 other wise the 3-D Object is downloaded on an element by element basis, step 124 and step 125 until all of the elements for a given 3-D object are downloaded, step 125. As each of the elements of a 3-D object are downloaded, step 124, each element may be played or displayed in the environment or the entire object may be played or displayed, step 126. The system determines if all of the selected 3-D objects have been downloaded for that session, step 127 and the download stops, step 128. If all of the selected 3-D models are not downloaded, step 122, then the next selected 3-D model is downloaded, step 118 and the process continues as before.

It should be noted that either the Approval Server 9 or the Catalog URL may track information related to the download of 3-D objects to determine which objects are most popular. Demographic information may be collected and number of objects used in a particular environment tracked to aid the Catalog URL customer to properly stock the actual physical items. Other general statistical information may also be tracked such as the extent of object access on an object by object basis, the number of mouse clicks, the simulation time and such special events as may be determined in the future. This information will be encrypted and made available for viewing by the Catalog URL customer.

Finally a Fast View system is based on producing surface characteristics using subdivision surfaces which allows for enhanced image and model compression and streamed/dynamic mesh transmission of models over the Internet. By using this technology the system is able to minimize the geometry and image characteristics to a smaller size to further decrease download time. In addition, the number of polygons constructed by the implementation of subdivision surface algorithms may be selected to give a selected frame rate on any computer system.

The documents attached hereto entitled EON Reality, Inc. with figure of a picture of a human head on the front consisting of a power point presentation of 15 pages, and the Background Description entitled EON Server Software Platform, Dated Apr. 10, 2000 consisting of 10 Pages each of which is incorporated herein by reference.

While a specific embodiment of this invention has been described above, those skilled in the art will readily appreciate that many modifications are possible in the specific embodiment, without materially departing from the novel teachings and advantages of this invention. Accordingly, all such modifications are intended to be included within the scope of this invention.

We claim:

1. A method and system for loading and unloading three-dimensional object model files comprising of the steps of:
a. Splitting the file into more than one part;
b. Dynamically downloading the parts separately; and
c. Displaying a three-dimensional object from the downloaded parts.
